(19) United States
(12) Patent Application Publication
(10) Pub. No.: US 2017/0337050 A1
(43) Pub. Date: Nov. 23, 2017

(54) REMOTE MONITORING SYSTEM AND SERVER FOR UPDATING FIRMWARE, AND METHOD FOR SAME

(71) Applicant: Sharp Kabushiki Kaisha, Osaka (JP)

(72) Inventors: YOHHEI IWAMI, Osaka (JP); ISAO KAWACHI, Osaka (JP); MISUZU KAWAMURA, Osaka (JP); RYOUSUKE KURITA, Osaka (JP)

(73) Assignee: Sharp Kabushiki Kaisha, Osaka (JP)

(21) Appl. No.: 15/522,133

(22) PCT Filed: Oct. 26, 2015
(86) PCT No.: PCT/JP2015/080076

§ 371 Date: Apr. 26, 2017

(30) Foreign Application Priority Data
Oct. 28, 2014 (JP) 2014-218874

(51) Int. Cl. G06F 9/445; H04L 29/08; H04L 12/28

(52) U.S. Cl. CPC G06F 8/65; H04L 12/2814; H04L 67/34

(57) ABSTRACT

The present invention aims to provide a method by which a user recognizes that firmware of a control device related to a remote monitoring system is being updated. In a remote monitoring system including a mobile terminal operated by a user, a server that communicates with the mobile terminal, and the control device that communicates with the server, the mobile terminal communicates with the control device through the server, and the server knows start and completion of an update of firmware of the control device by communicating with the control device. In a case where an operating instruction to the control device is issued from the mobile terminal while the firmware of the control device is being updated, the server notifies the mobile terminal that the firmware of the control device is being updated.

### TECHNICAL FIELD

The present invention relates to a remote monitoring system and a server for updating firmware, and a method for the same.

### BACKGROUND ART

For example, PTL 1 is known as a technology by which users can know the power consumption of individual home appliances to enhance the awareness of the users regarding energy saving.

PTL 1 describes a system in which a result of measurement performed by a tap or a CT sensor is transmitted to a repeater, the tap measuring the consumption of power supplied from a wall socket to a home appliance, the CT sensor measuring the power supplied from a distribution board to the home appliance. The tap acquires and displays the measurement result stored in the repeater.

### CITATION LIST

### Patent Literature

PTL 1: Japanese Unexamined Patent Application Publication No. 2014-055798

### SUMMARY OF INVENTION

### Technical Problem

In a case where firmware used for the repeater in PTL 1 is updated, a user can recognize that the firmware is being updated by operating a tablet serving as an interface for operation because the repeater is an apparatus used through direct access from the tablet.

However, recently, some users have desired to monitor a power measurement result also outside the home, and a conceivable solution is thus a remote monitoring system in which the measurement result stored in the repeater in the description above is stored in a server on the Internet and can be monitored outside the home by using an apparatus such as a smartphone. However, in this case, the apparatus directly accessed by the smartphone or the like is the server, and the repeater is thus not the directly accessed apparatus. Accordingly, under the existing circumstances, when a user performs an operation related to the repeater, the user does not recognize that the firmware used in a control device such as the repeater is just being updated.

The present invention has been made in view of the aforementioned problem and aims to provide a system and a method that enable a user to recognize that a control device related to a remote monitoring system is updating firmware.

### Solution to Problem

To solve the problem described above, the present invention provides a remote monitoring system including a mobile terminal operated by a user, a server that communicates with the mobile terminal, and a control device that communicates with the server. In the remote monitoring system, the mobile terminal communicates with the control device through the server, and the server knows start and completion of an update of firmware of the control device by communicating with the control device. In a case where an operating instruction to the control device is issued from the mobile terminal while the firmware of the control device is being updated, the server notifies the mobile terminal that the firmware of the control device is being updated.

A server used for the present invention includes a first interface for performing communication with a control device that acquires information regarding a plurality of home appliances and a second interface for performing communication with a mobile terminal operated by a user. The server knows start and completion of an update of firmware of the control device through communication using the first interface. In a case where the server receives a signal output from the second interface through the first interface while the firmware of the control device is being updated, the server outputs, through the second interface, a signal indicating that the firmware of the control device is being updated.

A method for updating firmware according to the present invention is a method for updating firmware of a control device in a remote monitoring system including a mobile terminal operated by a user, a server that communicates with the mobile terminal and the control device that communicates with the server. The server knows start and completion of an update of the firmware of the control device. In a case where an operating instruction to the control device is issued from the mobile terminal while the firmware of the control device is being updated, the mobile terminal is notified that the firmware of the control device is being updated.

### Advantageous Effects of Invention

According to the present invention, the user can easily recognize that the firmware of the control device in the remote monitoring system is being updated.

### BRIEF DESCRIPTION OF DRAWINGS

FIG. 1 is a schematic configuration diagram of a remote monitoring system in a first embodiment.

FIG. 2 is a flowchart describing server operations related to an update of the firmware of a HEMS controller in the first embodiment.

FIG. 3 is a flowchart describing HEMS controller operations related to the update of the firmware of the HEMS controller in the first embodiment.

FIG. 4 is a flowchart describing HEMS controller operations related to an update of the firmware of a HEMS controller in a second embodiment.

FIG. 5 is a flowchart describing server operations related to the update of the firmware of the HEMS controller in the second embodiment.

### DESCRIPTION OF EMBODIMENTS

Hereinafter, embodiments of the present invention will be described with reference to the drawings.

### First Embodiment

(System Configuration)

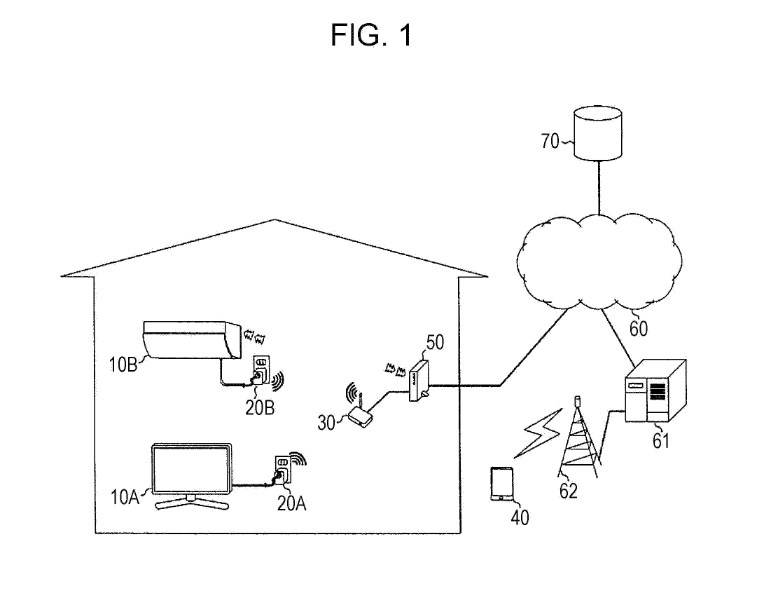

FIG. 1 is a diagram illustrating the schematic configuration of a remote monitoring system in a first embodiment.

The remote monitoring system illustrated in FIG. 1 includes home appliances 10 such as an air conditioner 10A and a television set 10B, taps 20 (20A and 20B) that measure the power consumption of the home appliances 10, a HEMS (Home Energy Management System) controller 30 that is a control device for remotely monitoring home appliances, a router 50 that is in wired connection with the HEMS controller 30 through Ethernet (registered trademark), and a mobile terminal 40 such as a smartphone used by a user for the remote monitoring. The remote monitoring system in this embodiment is capable of remotely controlling the home appliances 10 in addition to measuring the power consumption and amounts of power consumed by the home appliances 10 and monitoring the states of the home appliances 10.

A television set 10A of the home appliances 10 is an apparatus the power consumption of which is measured by the tap 20A (described later). In contrast, an air conditioner 10B is an apparatus the power consumption of which is measured by the tap 20B (also described later). In addition, the air conditioner 10B is an apparatus supporting for example, the ECHONETLite (registered trademark) standard and is a home appliance operation of which can be controlled in accordance with an ECHONETLite-compliant control instruction.

Each tap 20 includes a plug to be inserted into a wall socket and a receptacle into which a plug of the corresponding home appliance 10 is to be inserted. The tap 20 is disposed between the plug of the home appliance and the wall socket and thereby measures the power supplied to the home appliance. Information regarding the measured power is regularly transmitted to the HEMS controller 30 through communication supporting the ZIGBEE (registered trademark) standard. The information may be transmitted at transmission intervals of for example, five seconds. Alternatively, the tap 20 may calculate integral power consumption and transmit the integral power consumption to the HEMS controller 30, for example, every 15 minutes. The tap 20 is assigned a tap identification number that is a unique number used to discriminate the tap 20 from the other taps. The number may be printed so as to be visible from outside the tap 20 and may be browsable with the mobile terminal 40.

The HEMS controller 30 is a control device that transmits, to a server 70 (described later) through the router 50 (described later) and the Internet 60, power information and integral power consumption information transmitted from the tap 20. The HEMS controller 30 also receives an ECHONETLite-compliant control instruction transmitted from the server 70 and transmits the control instruction to the controlled apparatus (the air conditioner in this embodiment) 10B. At this time, the control instruction from the HEMS controller 30 is transmitted to the controlled apparatus 10B through the router 50. The HEMS controller 30 is similar to the repeater described in the background art in that the HEMS controller 30 receives the information transmitted from the tap 20 but is different in that the HEMS controller 30 transmits the received information to the server 70.

The mobile terminal 40 is represented by a smartphone. An application for browsing information regarding the measured power and an application used for remote control may be provided in such a manner as to be run by accessing the server 70 with a general web browser of the mobile terminal 40 or may be dedicated applications. A user can use the remote monitoring system by inputting the user ID assigned to the user and a password into the mobile terminal 40.

The router 50 is a general router and has a function of connecting to the Internet 60. The router 50 is provided with a wireless LAN (Local Area Network) supporting the IEEE802.11 standard and performs communications using the wireless LAN with the air conditioner 10B. In contrast, the router 50 is in wired connection with the HEMS controller 30 through Ethernet (registered trademark).

The server 70 includes an interface for communicating with the HEMS controller 30 and has functions of receiving and storing pieces of information regarding power, that is, the power and the integral power consumption that are transmitted from the HEMS controller 30. The server 70 also includes an interface for communicating with the mobile terminal 40. If the mobile terminal 40 makes a request, the server 70 provides the mobile terminal 40 with these pieces of information.

Further, the server 70 has a function by which if the mobile terminal issues an instruction for controlling the home appliance 10B that is a control target, the server 70 transmits the instruction to the HEMS controller 30. The communication between the server 70 and the mobile terminal 40 is performed through a network based on 3G (Generation), LTE (Long Term Evolution), or the like. A plurality of base stations 61 and a plurality of MMEs (Mobility Management Entities) 62 are provided for the network. The user can browse the measurement information and perform remote control not only at home but also outside the home and the like.

Although this embodiment is implemented by using one server 70, as a matter of course, the embodiment may include separate servers. The servers are respectively a server having functions related to the HEMS controller 30 such as the function of receiving the transmitted information regarding the power and the integral power consumption and the function of remotely controlling the home appliances and a server that provides the mobile terminal 40 with an application using a web browser. The servers communicate with each other in the configuration.

Note that a plurality of HEMS controllers 30 are connected to the server 70. In the configuration, identification numbers unique to the HEMS controllers (for example, MAC addresses) are stored in association with user IDs, respectively, and each HEMS controller 30 for the corresponding user is thereby identified.

As described above, the HEMS controller 30 plays a key role in a home network such as collecting pieces of measurement information and performing the remote control in the remote monitoring system in this embodiment. However, the HEMS controller 30 is characterized in that the HEMS controller 30 is not an apparatus controlled by being directly accessed by the user with the mobile terminal 40 or another apparatus but is an apparatus indirectly accessed via the server 70 that is directly accessed by the user. Being such an apparatus, the HEMS controller 30 can have a configuration without a display unit such as a liquid crystal screen for notifying the user near the HEMS controller 30 of the state of the HEMS controller 30.

(Updating Firmware)

The HEMS controller 30 has a plurality of functions, such as the remote monitoring function and the remote control, by which the information regarding the power consumption of the apparatuses 10 is received and transmitted to the server 70. Even if the HEMS controller 30 is in operation, it is desirable to update the firmware to enhance the convenience for the user in some cases.

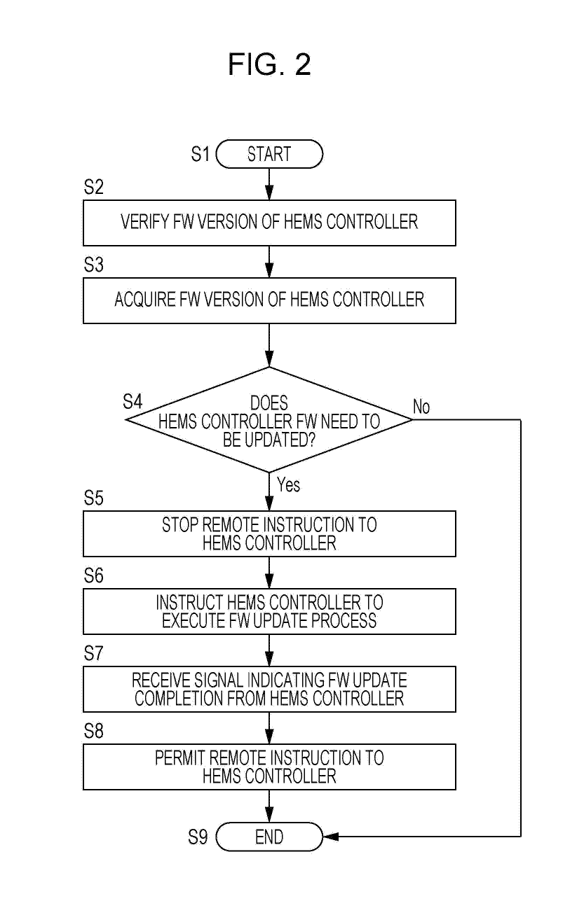

FIG. 2 is a flowchart of steps of updating the firmware of the HEMS controller 30 that are performed by the server 70.

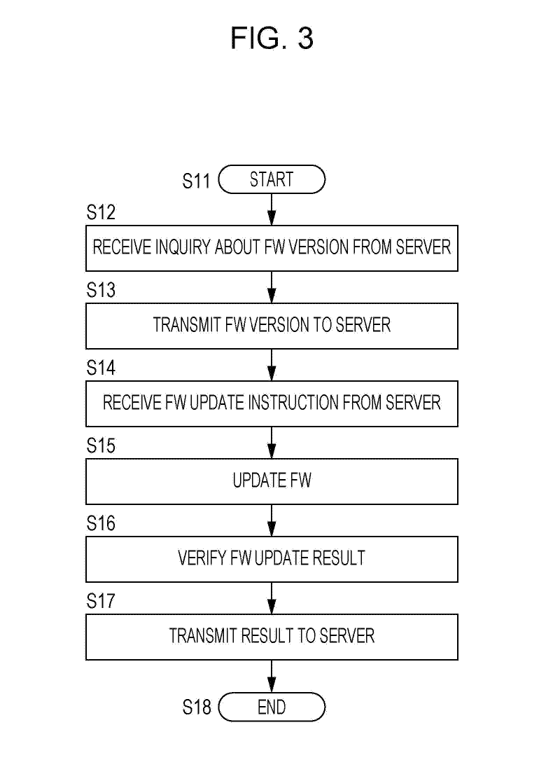

FIG. 3 is a flowchart of steps of updating the firmware of the HEMS controller 30 that are performed by the HEMS controller 30.

Hereinafter, the steps of updating the firmware (denoted by FW in the drawings) of the HEMS controller 30 will be described by using FIG. 2 and FIG. 3.

The server 70 accesses the HEMS controller 30 at a prescribed time or regularly (S2), acquires information regarding the version of the firmware of the HEMS controller 30 (S3), and judges whether the firmware of the HEMS controller 30 needs to be updated (S4).

If the server 70 judges that the firmware needs to be updated (Yes in S4), the server 70 changes the configuration to a configuration in which an operating instruction issued in accordance with an operation performed by a user on the mobile terminal 40 is not transmitted from the server 70 to the HEMS controller 30 (S5). The server 70 subsequently instructs the HEMS controller 30 to update the firmware (S6). After the elapse of a prescribed time, the server 70 receives, from the HEMS controller 30, a signal indicating that a firmware update process is complete (S7) and restores the configuration changed in S5 to the previous one (S8). If the server 70 judges that the firmware does not need to be updated (No in S4), the server 70 terminates the processing.

In contrast, upon receiving an inquiry about the firmware version from the server 70 (S12), the HEMS controller 30 transmits the version of the firmware of the HEMS controller 30 to the server (S13).

Upon receiving the instruction for updating the firmware from the server (S14), the HEMS controller 30 updates the firmware (S15). To update the firmware, the HEMS controller 30 downloads firmware for the update from the server 70 and thereafter saves information regarding a configuration set in accordance with a user operation in a storage area that is not used for the firmware update. Subsequently, the HEMS controller 30 temporarily stops the function as the HEMS controller, changes the operation mode to a mode for the firmware update, and performs the firmware update. At this time, an instruction made in accordance with a user operation is prevented from being transmitted in this embodiment. This is performed to prevent an unexpected signal from causing an unexpected operation because the operation mode for the firmware update does not support an operating instruction from the user. After the firmware update is complete, configuration information is restored to the temporarily saved configuration information and causes operations to function as the HEMS controller.

After the firmware update is complete, the HEMS controller 30 verifies the result (S16) and transmits the result to the server 70 (S17).

Note that in a period from step S5 to step S8, the server 70 can be accessed from the mobile terminal 40 of the user, while signal transmission to the HEMS controller 30 is stopped. Accordingly, if the user requests such a control screen that operates in relation to the HEMS controller 30 in real time, the server 70 notifies that the HEMS controller 30 is updating the firmware and a user operation cannot be performed at present. At this time, the server 70 may also display, together with the notification, an estimated time taken until the user can perform the operation. Regarding functions that are not influenced even if the firmware of the HEMS controller 30 is being updated, such as browsing measurement data stored in the server 70, the user can perform an operation for browsing as usual.

The server that recognizes the update state thereby notifies the user of the update even when an apparatus that cannot be directly accessed by the user is updating the firmware thereof. The user can thereby know that the apparatus is updating the firmware. Even if some of functions related to the remote monitoring are constrained, the user can be prevented from becoming confused.

Note that this embodiment has the configuration in which the server 70 inquires the HEMS controller 30 about the firmware at a prescribed time or regularly but may have a configuration in which the HEMS controller notifies the server of the version of the firmware of the HEMS controller 30 at a prescribed time or regularly or a configuration in which when the HEMS controller 30 transmits information to the server 70, the HEMS controller 30 notifies the server 70 of the version together with the information.

In addition, the HEMS controller 30 verifies the firmware update result and transmits the result to the server 70 in steps S16 and S17, respectively. However, the following configuration may also be employed. After updating the firmware, the HEMS controller 30 transmits information regarding the current firmware version. The server 70 judges whether the firmware version received from the HEMS controller matches an intended version. The server thereby recognizes that the firmware update has been successful and is complete.

### Second Embodiment

(System Configuration)

The basic configuration of this embodiment is the same as that of the first embodiment. In Embodiment 1, the server 70 checks the version of the firmware of the HEMS controller 30 and updates the firmware. This embodiment has a configuration in which the HEMS controller 30 verifies the firmware version stored in the server 70.

(Updating Firmware)

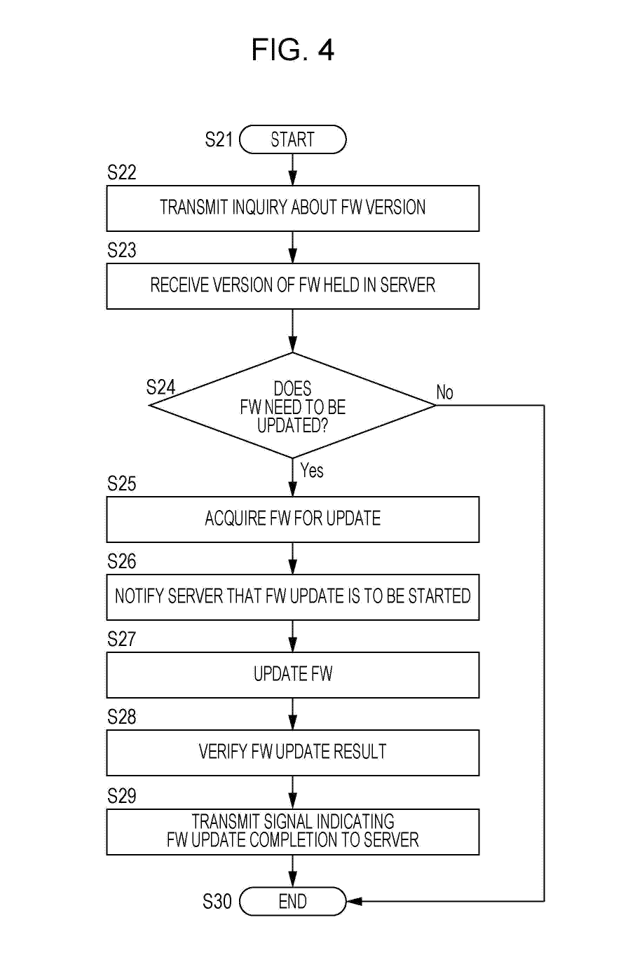

FIG. 4 is a flowchart of steps of updating the firmware of the HEMS controller 30 that are performed by the HEMS controller 30 in this embodiment.

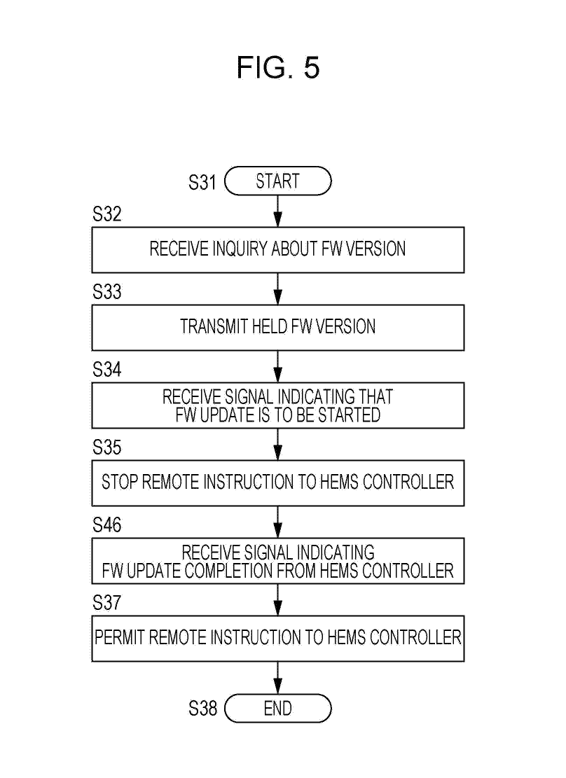

FIG. 5 is a flowchart of steps of updating the firmware of the HEMS controller 30 that are performed by the server 70.

Hereinafter, the steps of updating the firmware (denoted by FW in the drawings) of the HEMS controller 30 will be described by using FIG. 4 and FIG. 5.

The HEMS controller 30 inquires the server 70 about the firmware version at a prescribed time or regularly (S22) and receives information regarding the version of the firmware of a repeater held in the server (S23). If the version of the firmware held in the server is different from the version of the firmware of the HEMS controller 30, the HEMS controller 30 judges that the firmware needs to be updated (Yes in S24). The HEMS controller 30 subsequently downloads and acquires the firmware held in the server 70 (S25).

After acquiring the firmware for the update and before starting the update, the HEMS controller 30 notifies the server that the firmware update is to be started (S26). The HEMS controller 30 waits until a predetermined time elapses after the notification and then starts the firmware update. The HEMS controller 30 waits until the predetermined time elapses because a processing time is taken into consideration. During the processing time, a process is executed to prevent an operating instruction from a user from being transmitted after the server recognizes that the HEMS controller starts the firmware update. To update the firmware, the HEMS controller 30 saves information regarding a configuration set in accordance with a user operation in a storage area that is not used for the firmware update. Subsequently, the HEMS controller 30 temporarily stops the function as the HEMS controller, changes the operation mode to a mode for the firmware update, and performs the firmware update.

After the firmware update is complete, the HEMS controller 30 verifies the result of the firmware update (S28) and transmits, to the server 70, a signal indicating that the firmware update is complete.

In contrast, upon receiving, from the HEMS controller 30, an inquiry about the version of the held firmware of the HEMS controller (32), the server 70 transmits this to the HEMS controller (S33).

Upon receiving, from the HEMS controller 30, a signal indicating that the firmware update is to be started (S34), the server 70 changes the configuration, for the HEMS controller 30 that is to start the firmware update, to prevent an operating instruction from being transmitted from the server 70 to the HEMS controller 30, the operating instruction being issued in accordance with an operation performed by the corresponding user on the mobile terminal 40 (S35).

Subsequently, upon receiving, from the HEMS controller, a signal indicating that the firmware update is complete (S46), the server 70 cancels the configuration that is changed in step S35 to prevent the operating instruction from being transmitted from the server 70 to the HEMS controller 30, the operating instruction being issued in accordance with the operation performed by the corresponding user on the mobile terminal 40. The server 70 thus performs normal operations of the remote monitoring system.

Also in this embodiment, in a period from step S35 to step S37, the server 70 can be accessed from the mobile terminal 40 of the user, while signal transmission to the HEMS controller 30 is stopped. Accordingly, if the user requests such a control screen that operates in relation to the HEMS controller 30 in real time, the server 70 notifies that the HEMS controller 30 is updating the firmware and a user operation cannot be performed at present. At this time, the server 70 may also display, together with the notification, an estimated time taken until the user can perform the operation. Regarding functions that are not influenced even if the firmware of the HEMS controller 30 is being updated, such as browsing measurement data stored in the server 70, the user can perform an operation for browsing as usual.

The server that recognizes the update state thereby notifies the user of the update even when an apparatus that cannot be directly accessed by the user is updating the firmware thereof. The user can thereby know that the apparatus is updating the firmware. Even if some of functions related to the remote monitoring are constrained, the user can be prevented from becoming confused.

### Third Embodiment

The basic configuration of this embodiment is the same as that of the first embodiment.

In this embodiment, information indicating that the firmware update has failed is held in the server 70 when the update of the firmware of the HEMS controller 30 has failed in Embodiment 1 and Embodiment 2. Subsequently, when accessing the server 70 with the mobile terminal 40, a user is notified of a failure in the firmware update. In addition, whether the update is to be retried or the firmware is to be used without being updated is verified.

If the user selects the use of the current firmware without the update, the server 70 holds information regarding functions implementable by the firmware used at present by the user and functions implementable by firmware to be used for the update.

Applications for browsing information and for the remote control that are provided by the server 70 for the user terminal 40 do not vary depending on the firmware of the HEMS controller 30. Accordingly the selection made by the user not to update the firmware leads to the existence, in the mobile terminal 40, of functions that are not supported in a case where the firmware of the HEMS controller 30 is not updated.

Hence, this embodiment has the following configuration. The server holds the information regarding the functions implementable by the firmware used at present by the user and the functions implementable by the firmware to be used for the update. If the user attempts to use a function that is not implementable by the HEMS controller 30 corresponding to the user, a notification indicating that the use is impossible is displayed.

The configuration as described above enables an operating instruction to be appropriately issued even if the function of the firmware of the HEMS controller not configured to be directly accessed by the user with the mobile terminal 40 does not match the function of the application provided by the server directly accessed by the user with the mobile terminal 40.

The embodiments disclosed this time are examples, and the content thereof is not limited to that described above. The embodiments may be appropriately combined and modified.

### REFERENCE SIGNS LIST

10A home appliance (television set)
10B home appliance (air conditioner)
20A tap
20B tap
30 HEMS controller
40 mobile terminal
50 router
60 the Internet
61 base station
62 MME
70 server

1. A remote monitoring system comprising:
a mobile terminal operated by a user;
a server that communicates with the mobile terminal; and
a control device that communicates with the server,
wherein the mobile terminal communicates with the control device through the server, and
wherein the server knows start and completion of an update of firmware of the control device by communicating with the control device, and in a case where an operating instruction to the control device is issued from the mobile terminal while the firmware of the control device is being updated, the server notifies the mobile terminal that the firmware of the control device is being updated.

2. A server comprising:
a first interface for performing communication with a control device that acquires information regarding a plurality of home appliances; and
a second interface for performing communication with a mobile terminal operated by a user,
wherein the server knows start and completion of an update of firmware of the control device through communication using the first interface, and
wherein in a case where the server receives a signal output from the second interface through the first interface while the firmware of the control device is being updated, the server outputs, through the second interface, a signal indicating that the firmware of the control device is being updated.

3. A method for updating firmware of a control device in a remote monitoring system including
a mobile terminal operated by a user,
a server that communication with the mobile terminal, and
the control device that communicates with the server, the method comprising:
causing the server to know start and completion of an update of the firmware of the control device; and
in a case where an operating instruction to the control device is issued from the mobile terminal while the firmware of the control device is being updated, notifying the mobile terminal that the firmware of the control device is being updated.
